(19) United States
(12) Patent Application Publication
(10) Pub. No.: US 2011/0025317 A1
(43) Pub. Date: Feb. 3, 2011

(54) MsS PROBE FOR GUIDED-WAVE INSPECTION OF FUEL RODS

(75) Inventors: Hegeon Kwun, San Antonio, TX (US); Albert Joseph Parvin, JR., San Antonio, TX (US); Rolf Glauser, San Antonio, TX (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: ELECTRIC POWER RESEARCH INSTITUTE, INC., Charlotte, NC (US)

(21) Appl. No.: 12/845,808

(22) Filed: Jul. 29, 2010

Related U.S. Application Data
(60) Provisional application No. 61/230,147, filed on Jul. 31, 2009.

(51) Int. Cl. G01N 27/82

(52) U.S. Cl. 324/240

(57) ABSTRACT

The present application discloses a magnetostrictive sensor (MsS) probe for guided-wave inspection of the entire length of a fuel rod. The probe includes a waveguide adapted to be clamped to a fuel rod, and an MsS adapted to generate guided waves into the waveguide such that the guided waves propagate down the waveguide into the fuel rod and back to the waveguide for detection by the MsS.

### BACKGROUND OF THE INVENTION

This application claims the benefit of Provisional Application No. 61/230,147 filed on Jul. 31, 2009.

Fuel rods in nuclear reactors are typically made of a zirconium alloy (Zircaloy) tube approximately 0.4 inch (10 mm) in diameter, 0.03 inch (0.76 mm) in wall, and 14 feet (4 m) in length. They are assembled in a 14×14 to 18×18 grid for structural support and control of fuel. During an outage, these fuel rod assemblies are removed from the reactor to the fuel pools and inspected to ensure integrity of fuel rods before they are placed back in service to preclude a potential reactor coolant contamination issue. To inspect fuel rods in a timely manner during the critical path of outage, efficient inspection methods are needed for detecting flaws in rods such as fretting wear, corrosion wall thinning areas, and cracks.

Long-range guided-wave technique is a recently introduced inspection method for rapidly surveying a long length of pipe or tube for flaws from a given test location without mechanical scanning. Now widely used for examining pipelines in processing plants, this technique can provide a rapid and efficient inspection needed for fuel rods.

### BRIEF SUMMARY OF THE INVENTION

These and other shortcomings of the prior art are addressed by the present invention, which provides a magnetostrictive sensor (MsS) probe for guided-wave inspection of the entire length of a fuel rod from its top end.

According to one aspect of the present invention, an MsS guided wave probe for inspecting fuel rods includes a waveguide adapted to be clamped to a fuel rod, and an MsS adapted to generate guided waves into the waveguide such that the guided waves propagate down the waveguide into the fuel rod and back to the waveguide for detection by the MsS.

According to another aspect of the present invention, an MsS guided wave probe for inspecting fuel rods includes a waveguide having a first end with at least one slit therein. The first end is adapted to slide over an end of a fuel rod. The probe further includes a clamp adapted to be pushed downward along the axis of the waveguide and over the first end; an actuator adapted to actuate the clamp such that the clamp squeezes the first end against an outside surface of the fuel rod; and an MsS adapted to generate guided waves into the waveguide. The guided waves propagate down the waveguide into the fuel rod and back to the waveguide for detection by the MsS.

According to another aspect of the present invention, a method of inspecting a fuel rod includes the steps of providing an MsS guided wave probe; securing the probe to an end of a fuel rod; and generating guided waves and sending the guided waves into the waveguide such that the guided waves propagate down the waveguide into the fuel rod and back to the waveguide for detection by the MsS.

### BRIEF DESCRIPTION OF THE DRAWINGS

The subject matter that is regarded as the invention may be best understood by reference to the following description taken in conjunction with the accompanying drawing figures in which:

FIG. 1 shows a fuel rod MsS probe according to an embodiment of the invention;

FIG. 2 is a detailed view of an end of the probe of FIG. 1;

FIGS. 3 and 4 are graphs showing examples of 250 kHz data obtained using the probe of FIG. 1; and

FIG. 5 shows the probe of FIG. 1 inspecting fuel rods.

### DETAILED DESCRIPTION OF THE INVENTION

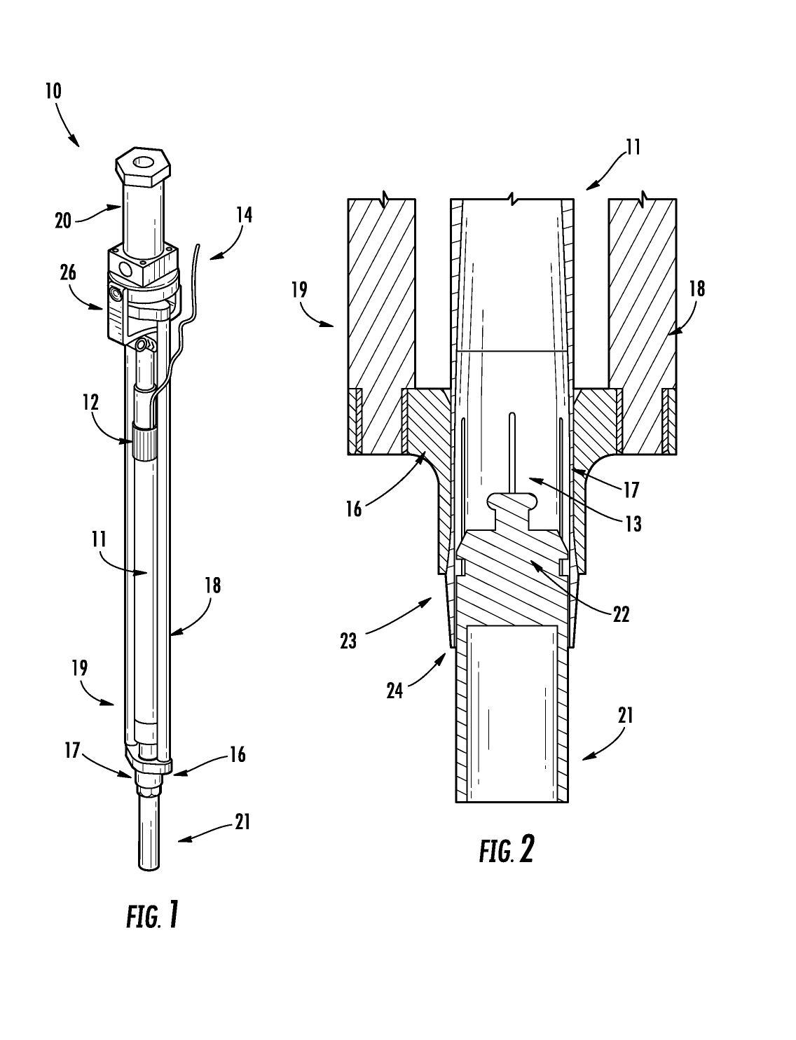

Referring to the drawings, an exemplary MsS probe for fuel rod inspection according to an embodiment of the invention is illustrated in FIG. 1 and shown generally at reference numeral 10. The probe 10 includes a waveguide 11, a magnetostrictive sensor (MsS) 12 connected to an MsS instrument (not shown) by an MsS cable 14, a clamp 16 for clamping a slit-end 17 (having slits 13, FIG. 2, therein) of the waveguide 11, clamp rods 18 and 19, and a clamp actuator 20 for actuating the clamp 16.

Referring to FIG. 2, for guided-wave inspection, the slit-end 17 of the waveguide 11 is sleeved over a top end 22 of a fuel rod 21 and mechanically clamped to the fuel rod 21 by pushing the clamp 16 downwards over the slit-end 17 and actuating the clamp 16 with the actuator 20, thereby squeezing the slit-end of the waveguide against an outside surface of the fuel rod 21.

The MsS 12 generates guided waves in the waveguide 11. The generated waves are then propagated down the waveguide 11, coupled to the fuel rod 21, and propagated along the fuel rod 21. The reflected signals are coupled back to the waveguide 11 and subsequently detected by the same MsS 12 used for wave generation.

The slit-end 17 of the waveguide 11 is tapered with a ridged area 23 near the tip 24. When the clamp 16 is moved downward over the ridged area 23, the clamp 16 presses the slit-end 17 of the waveguide 11 against the fuel rod 21. The resulting intimate contact between them permits the coupling of the guided waves from the waveguide 11 to the fuel rod 21 and vice versa.

To minimize the reverberation of guided waves in the waveguide 11 of the probe 10, damping material (not shown) is placed at a sensor end 26 of the waveguide 11. Also, the sensor end 26 of the waveguide 11 is mechanically fastened to the clamp actuator 20.

Both longitudinal (L) and torsional (T) guided waves can be used for fuel rod examination. However, T-waves are dispersion free and do not interact with water surrounding the fuel rods and the waveguide 11 of the MsS probe 10. Therefore, T-waves are the preferred wave mode. To minimize the effects of grids placed at several locations along the length of fuel rods in a fuel rod assembly, guided waves over 200 kHz are typically used.

The MsS utilizes the thin magnetostrictive strip approach disclosed in U.S. Pat. No. 6,396,262.

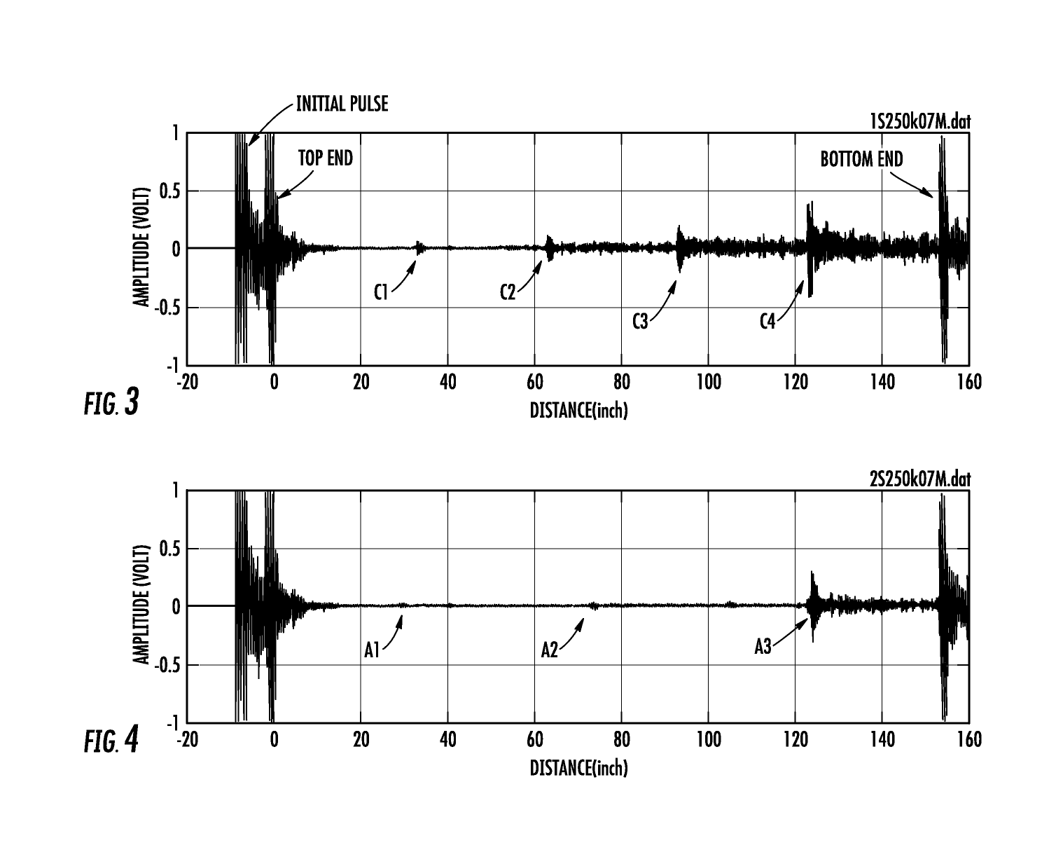

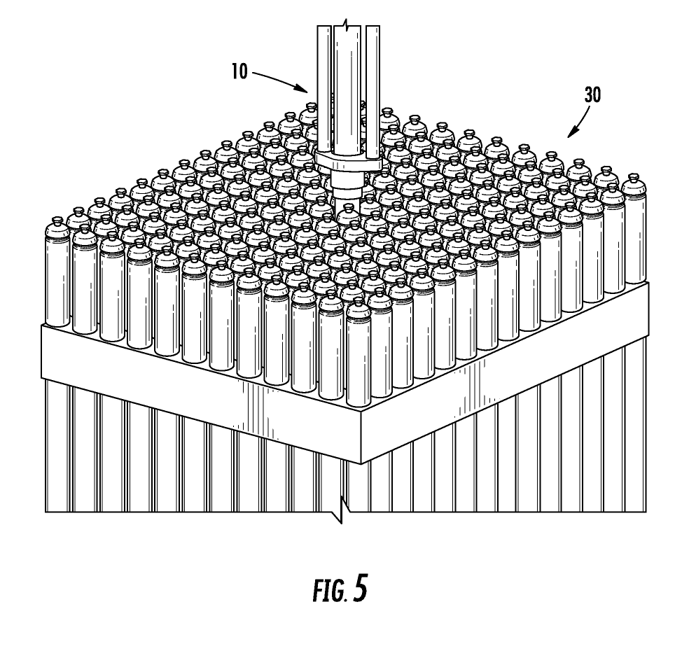

FIGS. 3 and 4 show examples of 250-kHz T-wave data obtained using the probe 10 from 154-inch-long fuel rod samples with simulated defects. C1 through C4 are signals from simulated corrosion pits. A1 through A3 are signals from 1-inch-long and 0.01-inch-wide axial EDM (electrical discharge machined) notches. C1 was approximately 0.18 inch-long, 0.12 inch-wide, and 28% wall deep; C2 was 0.21 inch long, 0.14 inch wide and 50% wall deep; C3 was 0.23 inch-long, 0.15 inch wide and 75% wall deep; C4 was 0.25 inch diameter through wall hole. A1 was 50% wall deep; A2 was 75% wall deep; A3 was 100% wall deep.

Tests conducted on fuel rod samples in the laboratory showed that the invention can inspect the entire length of a fuel rod from the top end of the fuel rod with good performance (as shown in the examples given in FIGS. 3 and 4) and that it can detect corrosion defects, wear and fretting defects, and cracks in any orientation (axial, circumferential, and 45-degree).

Referring to FIG. 5, in use, probe 10 may be used on a fuel assembly 30. Because the tip area of the probe 10 is only slightly larger than the fuel rod size, the probe 10 can couple to any fuel rod in the assembly 30 despite the close packed configuration of the assembly 30. The overall inspection time of the entire assembly 30 may be shortened by using an array of the probe 10 and a multiplexer. For example, for a 14×14 grid assembly, an array of 14 probes 10 are coupled simultaneously to all fuel rods in a grid row or column and each fuel rod is examined at a time by multiplexing each probe 10 using a single MsS instrument. The data acquisition time per fuel rod takes only several seconds. Thus, the entire fuel rod assembly, including the time for mechanical coupling and decoupling, could be completed in less than 30 minutes.

The foregoing has described an MsS probe for guided-wave inspection of fuel rods. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. An MsS guided wave probe for inspecting fuel rods, comprising:
(a) a waveguide adapted to be clamped to a fuel rod;
(b) an MsS adapted to generate guided waves into the waveguide such that the guided waves propagate down the waveguide into the fuel rod and back to the waveguide for detection by the MsS.

2. The MsS guided wave probe according to claim 1, wherein the waveguide includes a slit-end having a plurality of slits therein, the slit-end being adapted to slide over a top of the fuel rod to allow the waveguide to be clamped thereto.

3. The MsS guided wave probe according to claim 1, further including a clamping system for clamping the waveguide to the fuel rod.

4. The MsS guided wave probe according to claim 1, wherein the clamping system includes a clamp and an actuator connected to the clamp by clamp rods and adapted to actuate the clamp.

5. The MsS guided wave probe according to claim 1, further including an array of waveguides adapted to be clamped to an array of fuel rods such that the probe inspects the entire array and the same time.

6. An MsS guided wave probe for inspecting fuel rods, comprising:
(a) a waveguide having a first end with at least one slit therein, the first end being adapted to slide over an end of a fuel rod;
(b) a clamp adapted to be pushed downward along the axis of the waveguide and over the first end;
(c) an actuator adapted to actuate the clamp such that the clamp squeezes the first end against an outside surface of the fuel rod; and
(b) an MsS adapted to generate guided waves into the waveguide such that the guided waves propagate down the waveguide into the fuel rod and back to the waveguide for detection by the MsS.

7. The MsS guided wave probe according to claim 6, wherein the first end is tapered and includes a ridged area near a tip of the first end.

8. The MsS guided wave probe according to claim 7, wherein when the clamp is moved downward, the clamp moves over the ridged area and presses the first end against the fuel rod.

9. The MsS guided wave probe according to claim 6, wherein the first end includes a plurality of slits.

10. The MsS guided wave probe according to claim 6, further including at least one clamp rod connecting the clamp to the actuator.

11. The MsS guided wave probe according to claim 6, wherein the waveguide is cylindrical.

12. A method of inspecting a fuel rod, comprising the steps of:
(a) providing an MsS guided wave probe;
(b) securing the probe to an end of a fuel rod;
(d) generating guided waves and sending the guided waves into the waveguide such that the guided waves propagate down the waveguide into the fuel rod and back to the waveguide for detection by the MsS.

13. The method according to claim 12, wherein the step of securing the probe to the end of the fuel rod further includes the step of sliding an end of the probe over the end of the fuel rod and clamping the end of the probe against the end of the fuel rod.

14. The method according to claim 13, wherein the step of securing the probe to the end of the fuel rod further includes the step of sliding a clamp downward along an axis of the waveguide and over the end of the probe to allow the end of the probe to be clamped to the end of the fuel rod.
